(19) United States
(12) Patent Application Publication
(10) Pub. No.: US 2018/0180566 A1
(43) Pub. Date: Jun. 28, 2018

(54) REFERENCE ELECTRODE HOLDING MEMBER AND SUBSTANCE DETECTION DEVICE

(71) Applicant: National University Corporation Nagoya University, Aichi (JP)

(72) Inventor: Kazuo NAKAZATO, Aichi (JP)

(21) Appl. No.: 15/556,576

(22) PCT Filed: Mar. 4, 2016
(86) PCT No.: PCT/JP2016/056849

§ 371 Date: Feb. 14, 2018

(30) Foreign Application Priority Data
Mar. 7, 2015 (JP) 2015-045373

(51) Int. Cl. G01N 27/30; G01N 27/02; G01N 27/403

(52) U.S. Cl. CPC G01N 27/301; G01N 27/403; G01N 27/028

(57) ABSTRACT

Provided is a reference electrode-holding member that is highly operable and that has conductive lines that are not easily contaminated. Also provided is a substance detection device. A reference electrode-holding member used in a substance detection device for electrochemically detecting a substance in a solution using a reference electrode that determines an electrical reference for a solution, wherein the reference electrode-holding member includes at least a base material, a reference electrode-holding hole formed in the base material, a reference electrode flow channel, and a first flow channel, a sensor-facing surface that faces an electrochemical sensor of the substance detection device is formed on the base material, the reference electrode-holding hole is formed in a portion of the base material other than the sensor-facing surface and is capable of holding a reference electrode that can be inserted therein, one end of the reference electrode flow channel forms an opening in a portion of the base material other than the sensor-facing surface, the other end is positioned inside the base material, the distal end of the reference electrode-holding hole is in communication with the reference electrode flow channel at a location other than an end part of the reference electrode flow channel, one end of the first flow channel forms an opening in a portion of the base material other than the sensor-facing surface, the end forms an opening in the sensor-facing surface of the base material, the other end of the reference electrode flow channel and the first flow channel are in communication inside the base material, and, as a result of the reference electrode-holding member, operability is high and the conductive lines are not easily contaminated.

### BACKGROUND OF THE INVENTION

### 1. Field of the Invention

The present disclosure relates to a substance detection device for electrochemically detecting a substance in a solution with the aid of an electrochemical sensor (semiconductor IC sensor) in contact with the solution using a reference electrode for establishing an electrical reference of the solution, and relates to a reference electrode-holding member constituting the substance detection device. The present disclosure more particularly relates to a substance detection device for electrochemically detecting DNA, protein, cells, bacteria, viruses, glucose, and other biomolecules and biological substances as examples of substances to be detected, using variations in electric potential, electric current, and impedance, and relates to a reference electrode-holding member constituting the substance detection device.

### 2. Description of the Related Art

A substance detection device for detecting a specific biomolecule, biological substance, or the like often performs detection by bringing about a reaction with a molecule for detection. For example, the process uses the fact that a molecule binds solely with a specific molecule or chemically reacts solely with a specific molecule. In this case, it is effective to interpose an antibody or enzyme to improve detection precision. Also, electrochemical measurement techniques for detecting variations in electric potential, electric current, and impedance are often used to convert the binding or electrochemical reaction with the molecule for detection to an electrical signal (see patent documents 1 to 5 below).

Other examples of prior art include: non-patent document 1, which describes a method for detecting the presence of molecular binding using an FET gate as variation in electric charge; non-patent document 2, which describes a method for using an enzyme reaction to transcribe a specific molecular concentration to a concentration ratio of oxidants and reductants, and perform detection using an FET gate as the reduction-oxidation electric potential; non-patent document 3, which describes a method for using an enzyme reaction to detect the concentration of a specific molecule as the reduction-oxidation electric current; and non-patent document 4, which describes a method for capturing a specific virus with the aid of an antibody disposed on an electrode, and detecting the virus as variation in impedance.

### PRIOR ART DOCUMENTS

### Patent Documents

[Patent Document 1] U.S. Pat. No. 8,129,978

[Patent Document 2] JP (Kokai) 2015-210233

[Patent Document 3] JP (Kokai) 2012-47536

[Patent Document 4] JP (Kokai) 2010-256140

### Non-Patent Documents

[Non-Patent Document 1] P. Bergveld, “Thirty years of ISFETOLOGY: What happend in the past 30 years and what may happen in the next 30 years,” Sensor and Actuators B 88 (2003) pp. 1-20

[Non-Patent Document 2] Y.Ishige, M.Shimoda, and M.Kamahori, “Extended-gate FET-based enzyme sensor with ferrocenyl-alkanethiol modified gold sensing electrode”, Biosens. Bioelectron.24(2009) pp. 1096-1102

[Non-Patent Document 3] H.Tanaka, P.Fiorini, S.Peeters, B.Majeed, T.Sterken, M. O. de Beeck, M.Hayashi, H.Yaku, and I.Yamashita, “Sub-micro-liter Electrochemical Single-Nucleotide-Polymorphism Detector for Lab-on-a-Chip System”, Japanese Journal of Applied Physics 51 (2012) 04DL02

[Non-Patent Document 4] Y.Ishige, Y.Goto, I.Yanagi, T.Ishida, N.Itabashi, and M.Kamahori, “Feasibility Study on Direct Counting of Viruses and Bacteria by Using Microelectrode Array”, Electroanalysis 4(1) (2012) pp.131-139

### SUMMARY OF THE INVENTION

### Problems To Be Solved By The Invention

In the electrochemical detection method described above, variation in the electric potential, electric current, and impedance are measured, but a reference electrode for establishing a reference point of the electric potential of a solution is required. FIG. 1 shows the basic principle of a conventional reference electrode. In the drawing, the reference symbol 1A1 is a conventional reference electrode, 1A2 is a solution, 1A3 is an electronic circuit (semiconductor substrate), 1A4 is a voltage source for establishing a electric potential relationship, V1 is a reference electric potential of the solution, and V2 is a reference electric potential (normally, ground electric potential) of the electronic circuit. The reference electrode 1A1 shown in FIG. 1 establishes the proper electric potential relationship between the solution 1A2 and the semiconductor substrate 1A3 for detecting electric potential, electric current, and impedance, and must be set at a distance from the electrochemical system. This is because the original signal for detecting the biomolecule is negated when the electrochemical reaction occurs at the reference electrode. A conventional reference electrode has a structure in which an electroconductive line 2A1 is embedded in a glass tube 2A2 filled with a saturated liquid 2A3, as shown in FIG. 2. In this case, a KCl or NaCl solution, or the like is used as the saturated liquid 2A3, and an Ag/AgCl or the like is used as the electroconductive line 2A1. The glass tube is filled with a saturated liquid highly concentrated to saturation, the solution 1A2 is prevented from affecting the electroconductive line even if the solution diffuses in the glass tube, and an electrical connection is made with the solution in a state of chemical separation from the solution.

However, when the saturated liquid 2A3 has conversely diffused (2A6) in the solution 1A2, there is a drawback in that the ion density of the solution changes, the biological substance is affected, and detection precision is reduced. The ion concentration of the solution that is ordinarily used is 0.1 or less of the ion concentration of the saturated liquid. FIG. 3 shows the method for electrochemical measurement using a conventional flow system. In the drawing, the reference symbol 3A1 is a syringe, 3A2 is a sample fluid, 3A3 is a buffer solution, 3A4 is a flow channel switch valve, 1A2 is a solution on a substrate, 1A3 is a semiconductor substrate, 1A1 is a reference electrode, 3A8 is an electric wire, 1A4 is a voltage source, and 3A10 is a flow channel joint, and, as a method for avoid an effect on the saturation liquid, a solution is allowed to constantly flow and the reference electrode 1A1 is disposed downstream, thereby using the flow system for ensuring the saturated solution does not reach a sensor, as shown in FIG. 3. In this configuration, there are problems such as those described below, and such are an obstacle device operability and size reduction.

First, saturated liquid must be kept constantly filled in the glass tube, and the conventional reference electrode shown in FIG. 2 is required to be removed from the device when measurement is not carried out, and immersively stored in the saturated solution. On the other hand, the reference electrode must be mounted in the device each time measurement is performed. At this point, electrical connection with the solution is lost when foam 4A1 contaminates the tip of the reference electrode as shown in FIG. 4, and foam must therefore be removed with considerable care. These drawbacks dramatically compromise operability. Furthermore, a conventional reference electrode is made of a glass tube, and therefore size reduction is difficult.

Also, the electric potential of the reference electrode establishes the reference electric potential of a solution, and when noise reaches the reference electrode, there is a direct effect on detection signals. When electromagnetic shielding is provided to include the reference electrode in order to avoid this problem, the overall size of the device is increased.

In order to solve these problems, the glass tube and the saturation solution must be removed from the reference electrode, which must be an electroconductive wire alone, but when the protection of the electroconductive wire is removed, there is a problem in that the electroconductive wire comes into contact with the sample in the conventional configuration of FIG. 3, a chemical reaction is produced, and the electroconductive wire is contaminated (affected by noise or the like) and cannot be used as a reference point for electric potential.

### Means for Solving the Abovementioned Problems

The present disclosure was devised in order to solve the above-described problems, and an object thereof is to provide a substance detection device that can be reduced in size, that has high operability, and in which the electroconductive wire is unlikely to be contaminated (i.e., resistant to noise and the like), and to provide a reference electrode-holding member constituting the substance detection device.

The configuration of the present disclosure for solving the above-described problems is described below.

(1) A reference electrode-holding member to be used in a substance detection device for electrochemically detecting a substance in a solution using a reference electrode for establishing an electrical reference of the solution, wherein

the reference electrode-holding member comprises at least a base material, a reference electrode-holding hole formed in the base material, a reference electrode flow channel, and a first flow channel,

a sensor-facing surface that faces an electrochemical sensor of the substance detection device is formed in the base material,

the reference electrode-holding hole is formed in a portion other than the sensor-facing surface of the base material and is capable of receiving insertion of and holding the reference electrode,

one end of the reference electrode flow channel forms an opening in a portion other than the sensor-facing surface of the base material, and the other end is positioned inside the base material,

the distal end of the reference electrode-holding hole is in communication with the reference electrode flow channel in a location other than the end part of the reference electrode flow channel,

one end of the first flow channel forms an opening in a portion other than the sensor-facing surface of the base material and the other end forms an opening in the sensor-facing surface of the base material, and

the other end of the reference electrode flow channel and the first flow channel are in communication inside the base material.

(2) The reference electrode-holding member of (1) above, further comprising a second flow channel, of which one end forms an opening in a portion other than the sensor-facing surface of the base material, and the other end forms an opening in the sensor-facing surface of the base material.

(3) The reference electrode-holding member of (1) or (2) above, wherein
the first flow channel comprises at least one or more branching flow channels, and
the end part of the branching flow channel branched from the first flow channel forms an opening in the sensor-facing surface.

(4) The reference electrode-holding member of (1) or (2) above, wherein

two or more of the first flow channel are provided, and

one end of each of the first flow channels forms an opening in a portion other than the sensor-facing surface of the base material, the other end forms an opening in the sensor-facing surface of the base material, and at least one of the first flow channels is in communication with the reference electrode flow channel inside the base material.

(5) The reference electrode-holding member of any of (1) to (4) above, wherein a flow channel is formed in the sensor-facing surface.

(6) The reference electrode-holding member of any of (1) to (5) above, further comprising a reference electrode, the reference electrode being a conductor wire, and at least a portion of the conductor wire being positioned inside the reference electrode flow channel when inserted and held in the reference electrode-holding hole.

(7) A substance detection device comprising; the reference electrode-holding member of (6) above, an electrochemical sensor for electrochemically detecting a substance in a solution, and a voltage source.

(8) The substance detection device of (7) above, comprising a valve for switching the solution to be supplied to the first flow channel and the reference electrode flow channel.

(9) The substance detection device of (7) or (8) above, wherein the electrochemical sensor is capable of detecting at least one or more of electric potential, electric current, and impedance.

### Effects of the Invention

When a substance detection device is fabricated using the reference electrode-holding member of the present disclosure, a reference electrode is capable of constantly providing an invariable reference electric potential under the same environment. In the reference electrode-holding member of the present disclosure, the arrangement of the reference electrode-holding hole, the reference electrode flow channel, and the first flow channel has been devised such that the reference electrode can be washed with the reference electrode-holding member set so as to face the sensor. Adopting these configurations allows the glass tube and saturated solution to be removed from the reference electrode, the reference electrode becomes more compact, and the substance detection device can be made smaller.

### BRIEF DESCRIPTION OF THE DRAWINGS

FIG. 1 shows the basic principle of a conventional reference electrode;

FIG. 2 shows a reference electrode that is conventionally used;

FIG. 3 shows the method for electrochemical measurement used in a conventional flow system;

FIG. 4 shows defective conduction when foam has adhered to the reference electrode;

FIGS. 5(A) and 5(B) are conceptual views of the present disclosure having a single first flow channel;

FIG. 6(A) is a conceptual view of the present disclosure having a plurality of first flow channels, FIG. 6(B) is a conceptual view of the present disclosure in which the first flow channel has a plurality of branching flow channels, FIG. 6(C) is a conceptual view of the present disclosure having a plurality of second flow channels, and FIG. 6(D) is a conceptual view of the present disclosure in which the second flow channel has a plurality of branching flow channels;

FIG. 7 is a view of an embodiment of the present disclosure, FIG. 7(A) being a plan view, FIGS. 7(B) and (C) being cross-sectional views, and FIG. 7(D) being a bottom view;

FIG. 8 is a view showing the method for securing the reference electrode in the present disclosure;

FIGS. 9(A) and 9(B) are views showing the solution control method of the present disclosure;

FIGS. 10(A) to 10(C) show solution flow in the present disclosure;

FIG. 11(A) is a photograph in lieu of a drawing and is a photograph of a fabricated substance detection device, FIG. 11(B) is a photograph in lieu of a drawing and is a photograph of a fabricated reference electrode-holding member, and FIG. 11(C) is a photograph in lieu of a drawing and is a photograph of a fabricated reference electrode;

FIG. 12 is a view showing the method used in the present disclosure to mount a printed circuit board, FIG. 12(A) being a plan view, FIG. 12(B) being a cross-sectional view, FIG. 12(C) being a photograph in lieu of a drawing and a photograph of a fabricated printed circuit board, and FIG. 12(D) being a photograph in lieu of a drawing and an enlarged photograph of the semiconductor substrate portion;

FIGS. 13(A) and 13(B) are photographs in lieu of drawings and show the printed substrate handling method used in the present disclosure;

FIG. 14 is a view showing an example of the substance detection device of the present disclosure, and is a lateral view showing the connection of the reference electrode-holding member and the printed circuit board;

FIGS. 15(A) and 15(B) are photographs in lieu of drawings and are photographs showing the connection of the semiconductor substrate and the lid for retaining the reference electrode-holding member;

FIGS. 16(A) and 16(B) show the method for incorporating a microchannel on a semiconductor substrate;

FIG. 17(A) shows an example of detecting a biological substance using the substance detection device of the present disclosure, and FIG. 17(B) is a photograph in lieu of a drawing and is a photomicrograph of the electrode portion;

FIG. 18(A) is a photograph in lieu of a drawing and is a photograph of the sensor array provided to the first semiconductor substrate, and FIG. 18(B) is a photograph in lieu of a drawing is an enlarged photograph of the sensor array;

FIG. 19 shows the interface circuit and circuit configuration of the first semiconductor substrate of the substance detection device of the present disclosure;

FIG. 20 is a photograph in lieu of a drawing and is a photograph of the second semiconductor substrate used in the substance detection device of the present disclosure, the sensor array for simultaneously detecting changes in electric potential, electric current, and impedance being integrated on the second semiconductor substrate;

FIG. 21 is a conceptual view of the method for bringing the electric potential, electric current, and impedance measurements together in the second semiconductor substrate;

FIG. 22 shows the configuration of the second semiconductor substrate;

FIG. 23 is a circuit diagram of the electric potential sensor cell constituting the second semiconductor substrate;

FIG. 24 is a diagram of the sensor cell bias circuit constituting the second semiconductor substrate;

FIG. 25 shows the electric current and voltage characteristics of the electric potential sensor cell constituting the second semiconductor substrate;

FIG. 26 is a circuit diagram of the electric current sensor cell constituting the second semiconductor substrate;

FIG. 27 is an electric current detector used in the array peripheral circuit of the second semiconductor substrate;

FIG. 28 is a mixer circuit diagram using the array peripheral circuit of the second semiconductor substrate;

FIG. 29 is a diagram in which each component circuit of the second semiconductor substrate has been connected;

FIG. 30 is a chip photograph of the third semiconductor substrate;

FIG. 31 is a chart in which the temperature has been controlled using the third semiconductor substrate; and

FIG. 32 shows the configuration of the third semiconductor substrate.

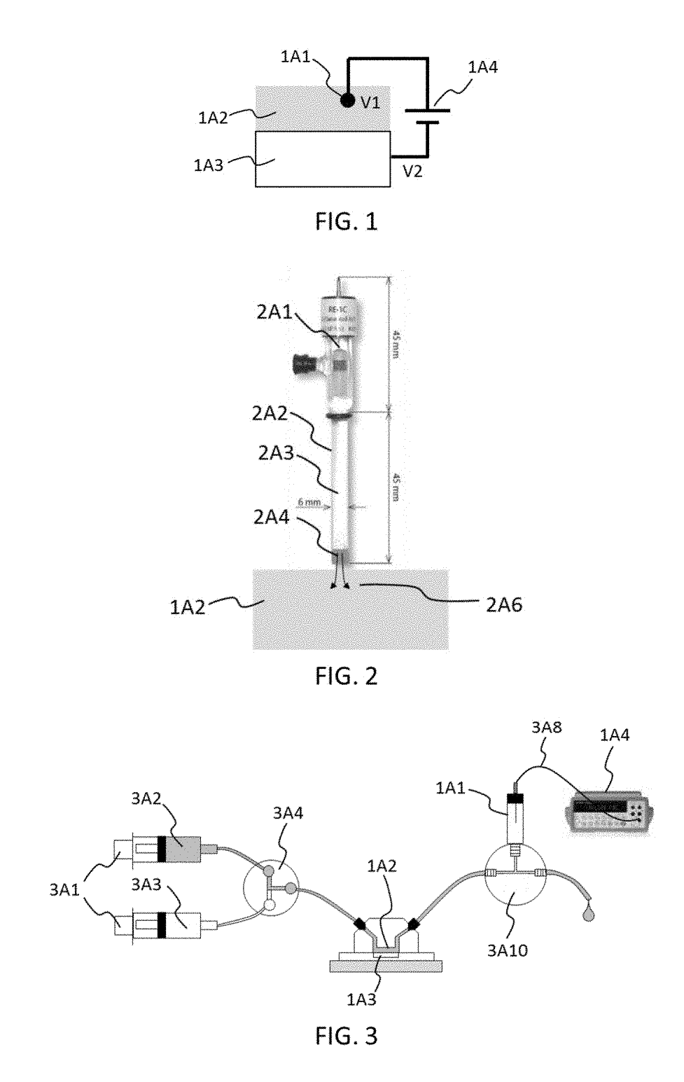

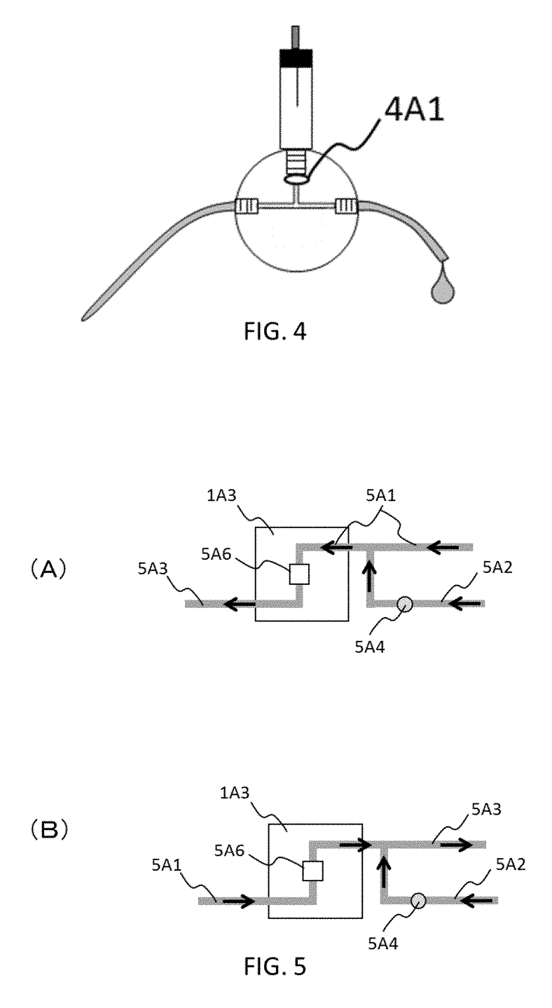

### DESCRIPTION OF THE PREFERRED EMBODIMENTS

The present disclosure is described below with reference to the drawings on the basis of preferred embodiments. The present disclosure is not limited to the embodiments described below, and modifications or the like of the present embodiments are also included in the scope of rights of the present disclosure.

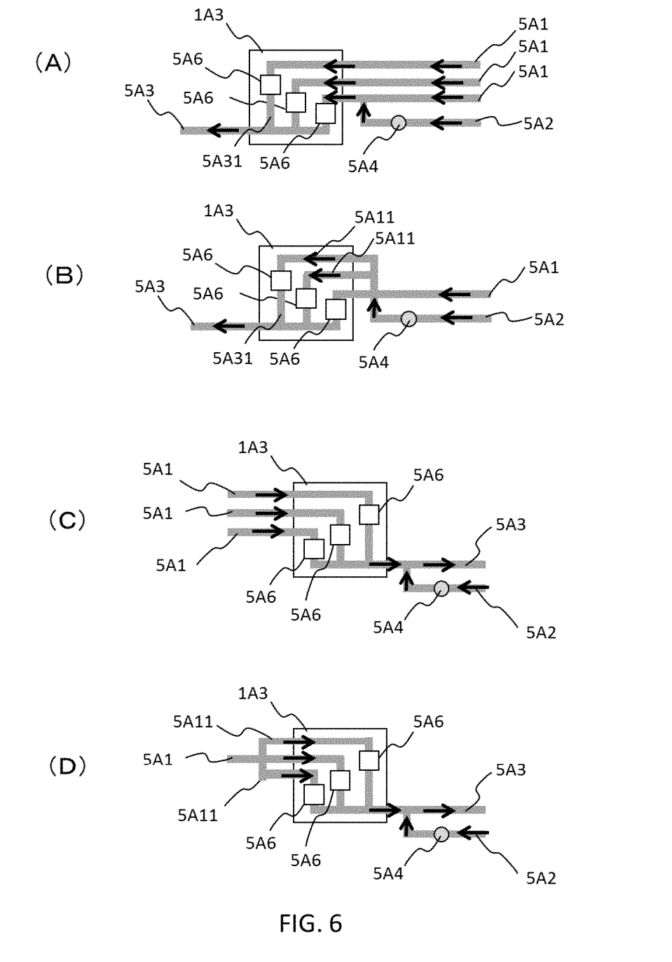

FIGS. 5 and 6 schematically illustrate the substance detection device of the present disclosure. FIG. 5(A) is a block diagram of the case in which there is a single flow channel, the first flow channel is used as a sample flow channel, and the second flow channel is used as a drainage flow channel. The reference symbol 5A1 is a sample flow channel (first flow channel), 5A2 is a reference electrode flow channel, 5A3 is a drainage flow channel (second flow channel), 5A4 is the reference electrode of the present disclosure, 1A3 is a semiconductor substrate, and 5A6 is an electrochemical sensor (semiconductor IC sensor, which hereinafter may be referred to merely as “sensor”). A buffer liquid constantly flows from the reference electrode flow channel 5A2 towards the semiconductor substrate 1A3, and therefore, the sample that flows through the sample flow channel 5A1 does not reach the reference electrode 5A4. In the embodiment shown in FIG. 5(A), a reference electrode wash liquid can be allowed to flow from the sample flow channel 5A1 (first flow channel) when the reference electrode 5A4 is to be washed. The reference electrode wash liquid that has flowed through the sample flow channel 5A1 (first flow channel) flows to the reference electrode flow channel 5A2, which is in communication with the sample flow channel 5A1 (first flow channel) at a midway point, and the reference electrode 5A4 can therefore be washed. In this process, the reference electrode flow channel 5A2 can be suctioned to facilitate the flow of the reference electrode wash liquid to the reference electrode flow channel 5A2. If the reference electrode wash liquid flows to the sensor, the sensor may be damaged. For this reason, it is possible to prevent the reference electrode wash liquid from flowing to the sensor by allowing the buffer liquid to flow from the drainage flow channel 5A3 (second flow channel) towards the sensor 5A6 when the reference electrode wash liquid is allowed to flow. In the case of the configuration shown in FIG. 5(A), the reference electrode wash liquid is allowed to flow from the sample flow channel 5A1 (first flow channel), but such a configuration is not necessarily required. For example, the sample flow channel 5A1 (first flow channel) and wash flow channel for allowing the reference electrode wash liquid to flow may be separate from each other. The sample liquid flows through the sample flow channel 5A1 (first flow channel) and is supplied to the sensor 5A6 on the semiconductor substrate 1A3, and therefore, the optimum electric potential relationship between the semiconductor substrate 1A3 and the solution can be established.

FIG. 5(B) is a block diagram of the case in which there is a single flow channel, the first flow channel is used as the drainage flow channel 5A3, and the second flow channel is used as the sample flow channel 5A1. In the case of the embodiment shown in FIG. 5(B), the sample liquid supplied from the sample flow channel 5A1 (second flow channel) to the sensor is discharged from the drainage flow channel 5A3 (first flow channel). In this process, buffer liquid is constantly flowing to the reference electrode flow channel 5A2, and the reference electrode flow channel 5A2 is in communication with the drainage flow channel 5A3 (first flow channel) at a midway point. Therefore, the buffer liquid flows to the drainage flow channel 5A3 (first flow channel) together with the sample liquid, and the sample that flows through the drainage flow channel 5A3 (first flow channel) does not reach the reference electrode 5A4. When the reference electrode 5A4 is to be washed, a reference electrode wash liquid can be allowed to flow in lieu of the buffer liquid to the reference electrode flow channel 5A2. In the embodiment shown in FIG. 5(B), the sample liquid, the buffer liquid, the drainage, and the like is switched in a simple manner as later described. Therefore, the number of components of the device can be reduced, and the device can be made smaller. The sample liquid flows through the sample flow channel 5A1 (second flow channel) to be supplied to the sensor 5A6 on the semiconductor substrate 1A3, and flows through the drainage flow channel 5A3 (first flow channel) to be drained away. Therefore, the optimum electric potential relationship between the semiconductor substrate 1A3 and the solution can be established.

FIG. 6(A) shows a configuration having a plurality of first flow channels (sample flow channels) and sensors. In FIG. 6(A), three sample flow channels 5A1 (first flow channels) are provided, and the end part of each sample flow channel 5A1 (first flow channel) face the sensor 5A6. The reference electrode flow channel 5A2 is in communication with at least one sample flow channel 5A1 (first flow channel) at a midway point of the flow channel. The sample liquid that has flowed through the sample flow channels 5A1 (first flow channels) is supplied to the sensor 5A6, and therefore, the reference electrode 5A4 is capable of making an electrical connection with all of the sample flow channels 5A1 via the solution on the semiconductor substrate 1A3. In the example shown in FIG. 6(A), the reference electrode flow channel 5A2 is in communication with a single sample flow channel 5A1 (first flow channel), but may also be in communication with all of the sample flow channels 5A1 (first flow channels) in the base material of the reference electrode-holding member. The buffer liquid flows from the reference electrode flow channel 5A2 towards the semiconductor substrate 1A3, and therefore, the sample that flows through the sample flow channels 5A1 does not reach the reference electrode 5A4. Thus, the plurality of first flow channels 5A1 serves a function as flow channels for supplying the sample liquid containing a substance to be detected to the plurality of sensors 5A6 in the solution. The drainage flow channel 5A3 (second flow channel) serves a function as flow channel for discharging the buffer liquid and the sample liquid supplied to the sensors 5A6. In the embodiment shown in FIG. 6(A), the drainage flow channel 5A3 (second flow channel) includes branching flow channels 5A31 having an end part near the sensors 5A6, but the branching flow channels 5A31 are not required. The number of sample flow channels 5A1 (first flow channels) is not particularly limited, but as described below, the sample flow channel 5A1 (first flow channel) is formed so as to pass through the middle of the base material of the reference electrode-holding member. Therefore, the number should be a number that allows the strength of the base material to be maintained with consideration given to the size of the base material, the thickness of the sample flow channel 5A1 (first flow channel), and other parameters.

FIG. 6(B) shows a configuration in which the sample flow channel (first flow channel) includes a branching flow channel. The embodiment shown in FIG. 6(B) is the same as the embodiment shown in FIG. 6(A), except that branching flow channels 5A11 are formed to branch from a midway point of a single sample flow channel 5A1 (first flow channel), and the other end of the branching flow channels 5A11 face the sensor 5A6. In the embodiment shown in FIG. 6(B), a sample liquid can be supplied without being affected by a chemical reaction with other sensors, even if there is a single pump or other device for supplying the sample liquid.

FIG. 6(C) is the embodiment shown in FIG. 5(B) and shows an embodiment in which a plurality of second flow channels (sample flow channel 5A1) and sensors 5A6 are provided. The configuration is otherwise the same as FIG. 5(B).

FIG. 6(D) is the same configuration as the embodiment shown in FIG. 6(C), except that branching flow channels 5A11 are formed to branch from a midway point of a single second flow channel (sample flow channel 5A1)

In the above-described configuration, the reference electrode is preferably a conductor wire (conductive wire) in that replacement is facilitated. In this case, a multipurpose wire made of, e.g., gold or platinum can be used as the conductor wire (conductive wire) serving as the reference electrode. Using such a configuration makes it possible to incorporate the reference electrode 5A4 into the substance detection device and obtain electromagnetic shielding, and allows noise to be considerably reduced.

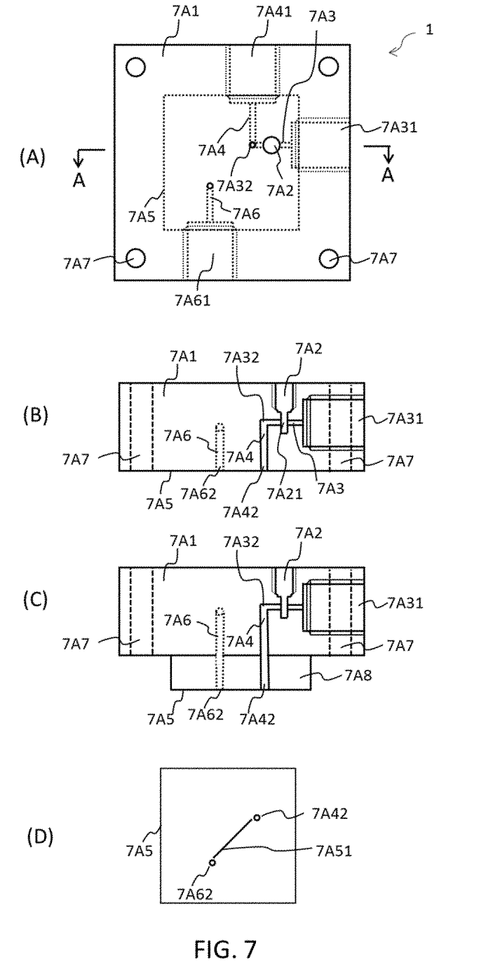

FIG. 7 is a view illustrating the general configuration of the reference electrode-holding member of the present disclosure, FIG. 7(A) is a plan view, FIGS. 7(B) and (C) are A-A cross-sectional views of FIG. 7(A), and FIG. 7(D) is a bottom view. As shown in FIGS. 7(A) to 7(C), the reference electrode-holding member 1 includes at least a base material 7A1, a reference electrode-holding hole 7A2 formed on the base material 7A1, a reference electrode flow channel 7A3, and a first flow channel 7A4.

The base material 7A1 is not particularly limited as long as it is a material that does not react with the sample or the like, and examples include polycarbonate, quartz, and Teflon (registered trademark). A sensor-facing surface 7A5 that faces the sensor 5A6 is formed on the base material 7A1. The reference electrode-holding hole 7A2 can be formed in any location as long as the location is a portion other than the sensor-facing surface 7A5 of the base material 7A1. One end of the reference electrode flow channel 7A3 forms an opening 7A31 in a portion other than the sensor-facing surface 7A5 of the base material 7A1. As shown in FIGS. 7(A) to 7(C), the opening 7A31 may be larger than the width of the reference electrode flow channel 7A3 to facilitate connection to a tube or the like. The other end 7A32 of the reference electrode flow channel 7A3 is positioned inside the base material 7A1. The distal end 7A21 of the reference electrode-holding hole 7A2 is in communication with the reference electrode flow channel 7A3 in a location other than the end parts 7A31, 7A32 of the reference electrode flow channel 7A3. Accordingly, when the later-described reference electrode of the present disclosure is inserted and held in the reference electrode-holding hole 7A2, at least a portion of the conductor wire, which is the reference electrode, can be positioned inside the reference electrode flow channel 7A3.

One end of the first flow channel 7A4 forms an opening 7A41 in a portion other than the sensor-facing surface 7A5 of the base material 7A1, and the other end forms an opening 7A42 in the sensor-facing surface 7A5 of the base material 7A1. The opening 7A41 may be larger than the width of the first flow channel 7A4 to facilitate connection to a tube or the like. The first flow channel 7A4 and the other end 7A32 of the reference electrode flow channel 7A3 are in communication with each other inside the base material 7A1.

The reference electrode-holding member 1 may include a second flow channel 7A6 as required. One end of the second flow channel 7A6 forms an opening 7A61 in a portion other than the sensor-facing surface 7A5 of the base material 7A1, and the other end forms an opening 7A62 in the sensor-facing surface 7A5 of the base material 7A1. The opening 7A61 may be larger than the width of the second flow channel 7A6 to facilitate connection to a tube or the like. In the case that the second flow channel 7A6 is not formed in the reference electrode-holding member 1, the sample liquid may be supplied to the sensor 5A6 using a tube or the like, and drainage on the sensor 5A6 may be drawn away.

A mounting hole 7A7 for mounting the reference electrode-holding member 1 on the substance detection device using a screw or the like may be formed in the reference electrode-holding member 1. The reference electrode-holding hole 7A2, the reference electrode flow channel 7A3, the first flow channel 7A4, the second flow channel 7A6, the openings 7A31, 7A41, 7A61, and mounting hole 7A7 can be formed by drilling or otherwise machining the base material 7A1.

FIG. 7(C) is a cross-sectional view showing another embodiment of the reference electrode-holding member 1 of the present disclosure. In the cross-sectional view shown in FIG. 7(C), a sheet part 7A8 is formed in the base material 7A1, and the sensor-facing surface 7A5 is formed in the sheet part 7A8. The function is the sheet part 7A8 will be described later. The opening 7A42 of the first flow channel 7A4 and the opening 7A62 of the second flow channel 7A6 can be formed in the sensor-facing surface 7A5 of the sheet part 7A8.

FIG. 7(D) is a bottom view showing another embodiment of the reference electrode-holding member 1 of the present disclosure. In the embodiment shown in FIG. 7(D), a third flow channel 7A51 is formed in the sensor-facing surface 7A5. Forming a third flow channel 7A51 facilitates adjustment of the direction of flow of the sample liquid or the like when the sample liquid or the like is loaded into or drawn out from the opening 7A42 of the first flow channel 7A4 and the opening 7A62 or the second flow channel 7A6. The number and shape of the third flow channel 7A51 is not particularly limited, and can be suitably adjusted in accordance with the number and arrangement of the sensor 5A6. The third flow channel 7A51 can be formed by cutting with a drill or the like. When the base material 7A1 or the sheet part 7A8 are PDMS or other pliant material, a mold having a convex part corresponding to the third flow channel 7A51 can be fabricated and transferred.

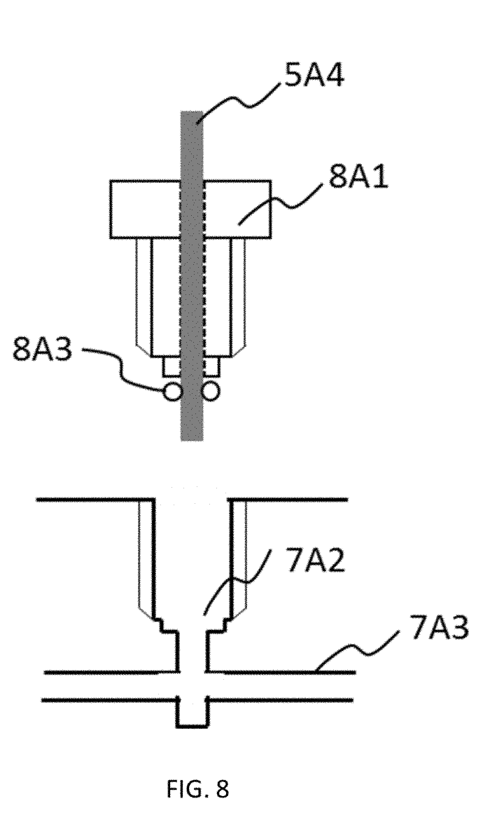

FIG. 8 is a view showing the method for securing the reference electrode in the present disclosure. In the drawing, the reference symbol 8A1 is a reference electrode-securing screw, 5A4 is a reference electrode (conductor wire), 8A3 is an O-ring, and 7A2 is a reference electrode-holding hole. As shown in FIG. 8, a hole is opened in the center of the screw, the reference electrode 5A4 (conductor wire) is passed therethrough, and secured to the reference electrode-holding hole 7A2 by way of an O-ring 8A3 for preventing water leakage. Since the reference electrode flow channel 7A3 and the distal end of the reference electrode-holding hole 7A2 are in communication with each other, the distal end portion of the reference electrode 5A4 (conductor wire) can be positioned inside the reference electrode flow channel 7A3. Accordingly, the reference electrode 5A4 is in contact with the buffer liquid that flows through the reference electrode flow channel 7A3, and is therefore not contaminated by the sample liquid or the like.

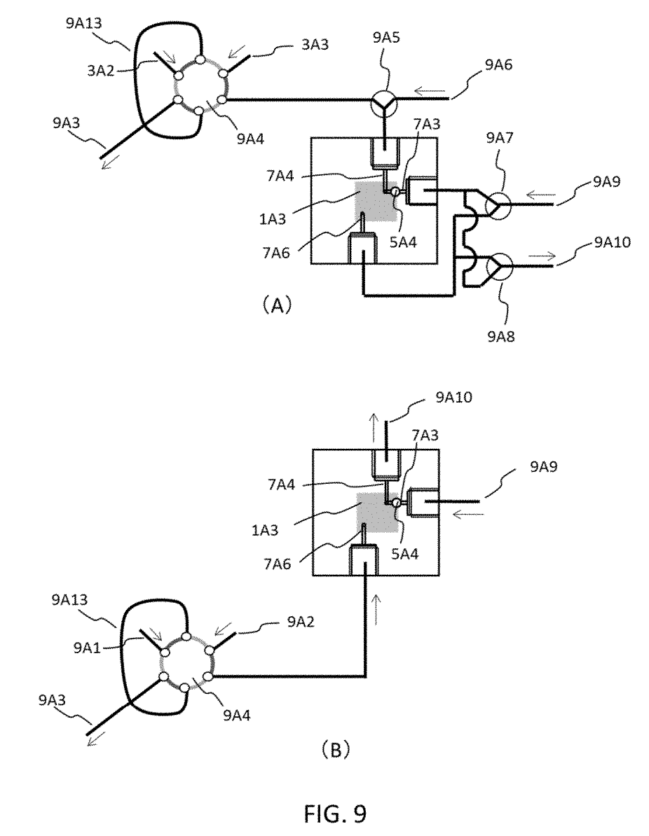

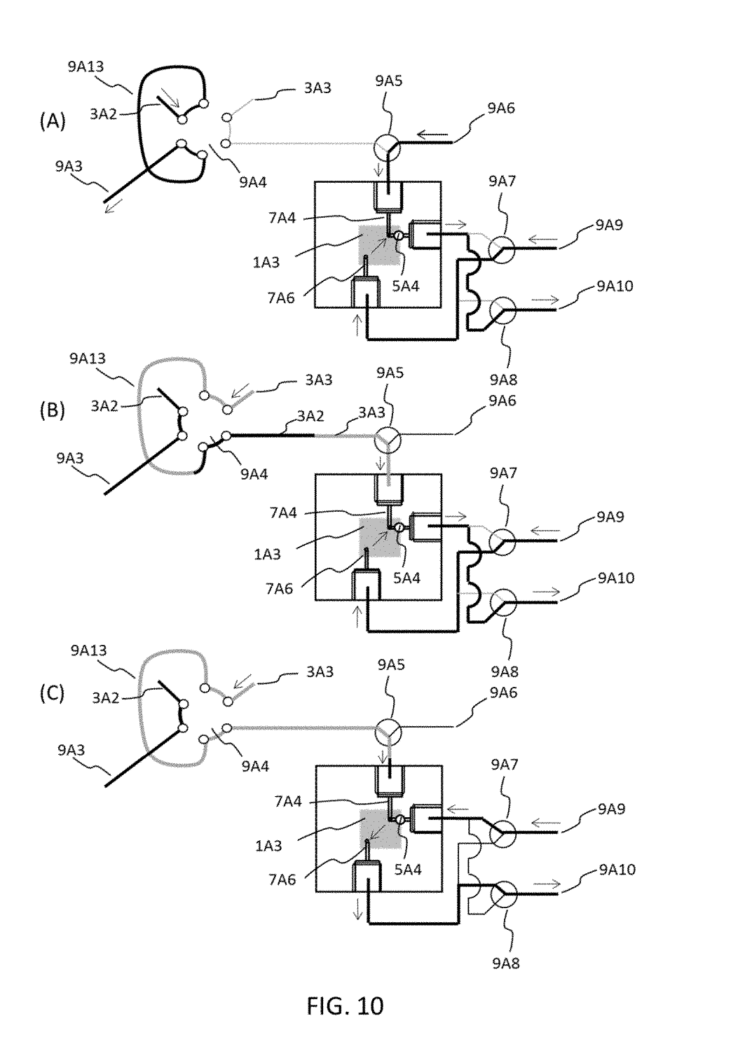

FIG. 9(A) shows the method for controlling the flow of solution when the first flow channel 7A4 is used as a sample flow channel and the second flow channel 7A6 is used as a drainage flow channel. The specific flow of solution is illustrated in FIG. 10. In the drawing, the reference symbol 3A2 is a sample liquid, 3A3 is a buffer liquid, 9A3 is drainage, 9A4 is a valve (six-way valve), 9A5, 9A7, 9A8 are valves (three-way valves), 9A6 is a reference electrode wash liquid, 9A9 is a buffer liquid, 9A10 is drainage, 5A4 is a reference electrode, 1A3 is a semiconductor substrate, and 9A13 is a tube for metering a sample liquid. The sample is accommodated in a tube 9A13 having a predetermined volume and is supplied to the semiconductor substrate 1A3 in succession to the buffer liquid, which does not contain the sample, whereby sample-induced variation is detected.

FIG. 9(B) shows the method for controlling the flow of solution when the first flow channel 7A4 is used as a drainage flow channel and the second flow channel 7A6 is used as a sample flow channel. In the case of the embodiment shown in FIG. 9(B), the second flow channel 7A6 may supply the sample liquid. The first flow channel can draw out and drain the drainage on the semiconductor substrate 1A3 and the buffer liquid 9A9 flowing to the reference electrode flow channel 7A3. When the reference electrode 5A4 is to be washed, the reference electrode wash liquid can be allowed to flow in lieu of the buffer liquid 9A9. In the embodiment shown in FIG. 9(B), the number of three-way valves can be reduced because the switching of the flow channel can be simplified. Therefore, the substance detection device can be made smaller.

FIG. 10 is a view for illustrating in greater detail the flow of solution of the embodiment shown in FIG. 9(A). (The components indicated by reference symbols in FIG. 10 are the same as those indicated by the reference symbols in FIG. 9.)

First, a solution containing a sample is filled into the tube 9A13 and the reference electrode 5A4 is washed by the reference electrode wash liquid 9A6, as shown in FIG. 10(A). The buffer liquid 9A9 flows through the second flow channel 7A6 to the semiconductor substrate 1A3, and therefore, the reference electrode wash liquid 9A6 does not reach the semiconductor substrate 1A3.

Next, the six-way valve 9A4 and the three-way valve 9A5 are switched, and the sample solution 3A2 stored in the tube 9A13 passes through the first flow channel 7A4 and is carried toward the semiconductor substrate 1A3, as shown in FIG. 10(B). At this point, the reference electrode wash liquid 9A6 downstream from the three-way valve 9A5 is pushed out by the buffer liquid 3A3.

Next, the three-way valves 9A7 and 9A8 are switched, the buffer liquid 9A9 flows to the reference electrode 5A4 to ensure that the sample solution 3A2 does not reach the reference electrode 5A4, as shown in FIG. 10(C). The buffer liquid 9A9 can merely be used for preventing the sample solution 3A2 from reaching the reference electrode 5A4, and by slowing sending the buffer liquid, the effect on the composition of the solution containing the sample can be minimized.

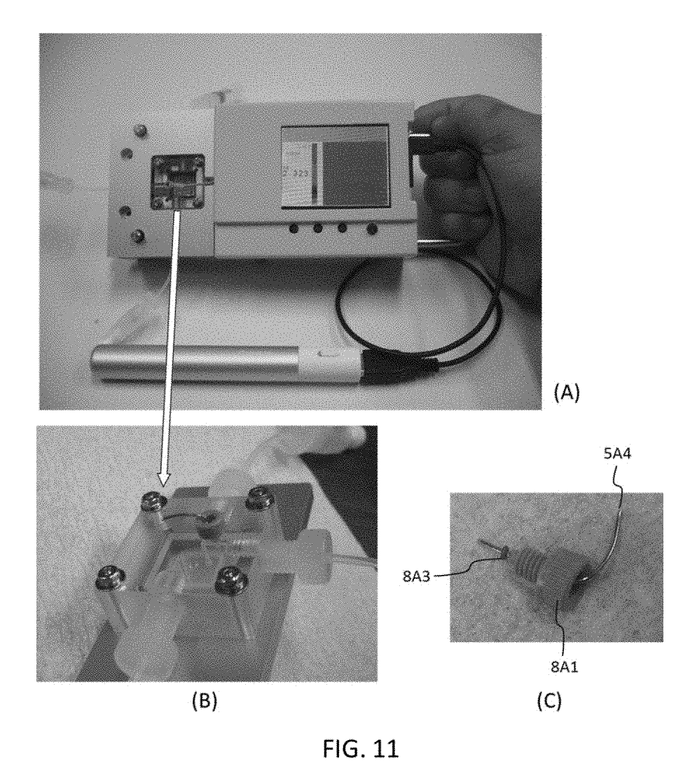

FIG. 11(A) is a photograph of the entire fabricated substance detection device, which has been compactly assembled including the reference electrode 5A4. Using a battery drive as the voltage source ensures a reduction in power supply noise. The reference electrode-holding member 1 including the reference electrode 5A4 is covered by a metal lid, whereby electromagnetic noise can be further reduced. FIG. 11(B) is a photograph of the reference electrode-holding member 1 fabricated by cutting polycarbonate using a drill. In the reference electrode-holding member 1 shown in FIG. 11(B), one each of the first flow channel 7A4 and the second flow channel 7A6 is formed, the openings in locations other than the sensor-facing surface 7A5 of the flow channels are formed to be wide and are connected to a tube using a ¼-28UNG (unified fine thread) screw. FIG. 11(C) is a photograph of the reference electrode 5A4. In the photograph, the reference symbol 8A1 is a reference electrode-securing screw, 5A4 is a reference electrode (gold wire), and 8A3 is an O-ring. FIG. 11(B) is an enlarged photograph of a portion of the substance detection device shown in FIG. 11(A), and the reference electrode-holding member 1 shown in FIG. 11(B) corresponds to the reference electrode-holding member 1 shown in FIG. 7. The reference electrode 5A4 shown in FIG. 11(C) corresponds to the reference electrode 5A4 shown in FIG. 8.

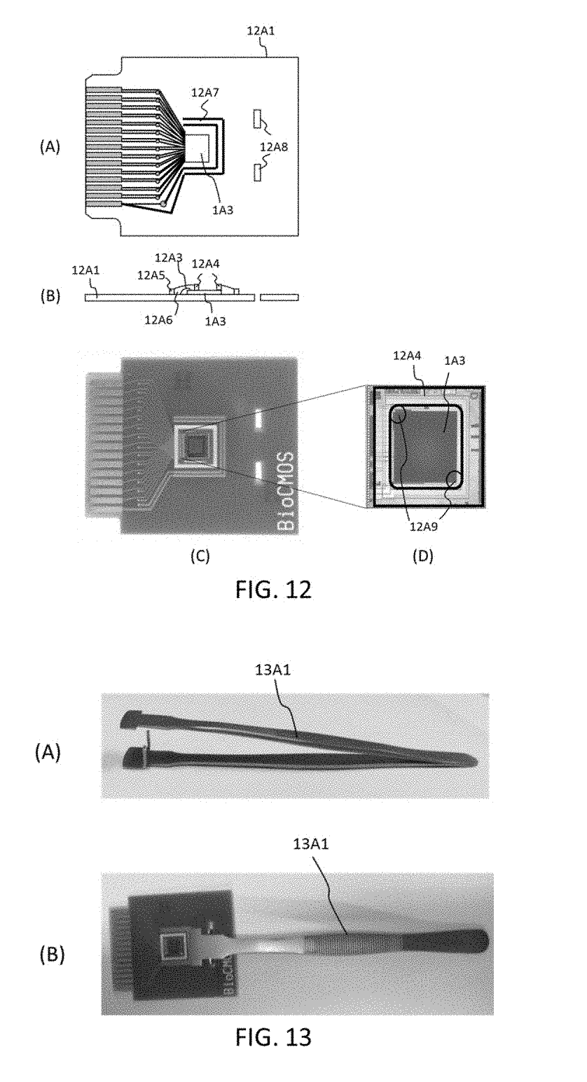

The semiconductor substrate 1A3, which makes contact with the sample liquid, is disposed on the printed circuit board shown in FIG. 12. In FIGS. 12(A), 12(B), 12(D), the reference symbol 12A1 is a printed circuit board, 1A3 is a semiconductor substrate, 12A3 is a bonding wire, 12A4, 12A5 are silicone sheet frames (frame bodies), 12A6 is a silicone paste, 12A7 is a counter electrode for detecting water leakage, 12A8 is a hole (removal section) for removing the printed circuit board, and 12A9 is the solution entry/exit position facing the opening 7A42 of the first flow channel 7A4 and the opening 7A62 of the second flow channel 7A6 in the reference electrode-holding member 1.

The semiconductor substrate 1A3 is die-bonded, and wire bonding using an electric wire 12A3 is thereafter carried out to provide electrical wiring. Silicone sheet frames 12A4, 12A5 are then disposed and a silicone paste 12A6 is applied therebetween to thereby protect the bonding wire 12A3. Counter electrodes 12A7 for detecting solution leakage are provided to the printed circuit board 12A1. When solution has leaked, the electrical resistance between the counter electrodes is reduced and an externally connected LED lights up to thereby provide a warning. FIG. 12(C) is a photograph of the printed circuit board, and FIG. 12(D) is an enlarged photograph of the semiconductor substrate 1A3 portion of the printed circuit board and shows the positional relationship between the semiconductor substrate 1A3, the silicone sheet frame 12A4, and the solution entry/exit positions 12A9 of the reference electrode-holding member 1.

The printed circuit board 12A1 is connected to an edge connector, but this connection is firm and requires a certain amount of force to remove the printed circuit board 12A1. The printed circuit board 12A1 is secured inside the device, and therefore an opening (hole) 12A8 for removing the printed circuit board is provided to a portion of the printed circuit board and tweezers 13A1 (removal tool) shown in FIG. 13 are used. In this case, removal projections on the tweezers 13A1 are fitted into the opening (hole) 12A8 of the printed circuit board to perform mounting and removal.

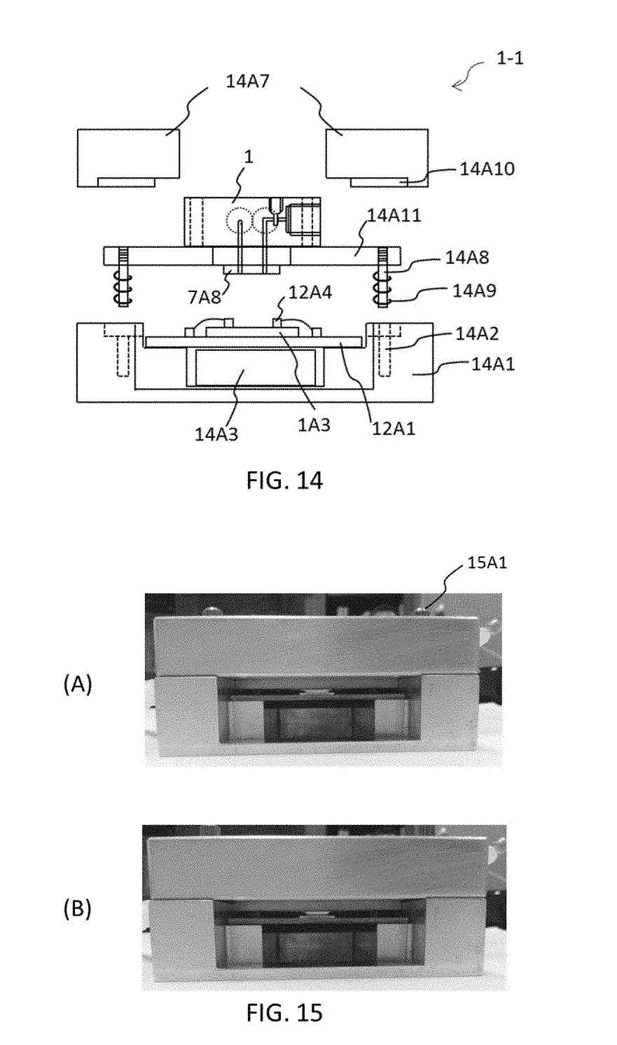

FIG. 14 shows an example of the substance detection device 1-1 of the present disclosure, and is a lateral view showing the connection of the reference electrode-holding member 1 and the printed circuit board 12A1. In FIG. 14, the reference symbol 12A1 is a printed circuit board, 14A1 is a printed circuit board-holding part for holding the printed circuit board 12A1, 1A3 is a semiconductor substrate, 14A3 is a magnet, 12A4 is a silicone sheet frame (frame body), 7A8 is a sheet part, 1 is a reference electrode-holding member, 14A7 is lid (support member) for retaining the reference electrode-holding member 1, 14A8 is an alignment pin of the reference electrode-holding member 1, 14A9 is a spring (elastic member), 14A10 is a silicone sheet (sheet material) for close adhesion, 14A11 is a fixed stainless steel plate of the reference electrode-holding member 1, and 14A2 is a pin insertion hole for inserting the alignment pin 14A8. In the example, shown in FIG. 14, the reference electrode-holding member 1 and the semiconductor substrate 1A3 are mounted so as to face each other with the fixed stainless steel plate 14A11 disposed therebetween, but the reference electrode-holding member 1 may be mounted so as to directly face the semiconductor substrate 1A3.

The reference electrode-holding member 1 is secured to the stainless steel plate 14A11, and a positioning pin 14A8 and spring 14A9 are provided to the stainless steel plate. A sheet part (made of a silicone sheet) 7A8 is formed on the lower surface of the reference electrode-holding member 1. Accordingly, water leakage is prevented by close adhesion of the silicone sheet 12A4 on the semiconductor substrate 1A3 secured to the printed circuit board 12A1. The lid 14A7 retains the stainless steel plate by way of the silicone sheet 14A10.

FIG. 15 is a photograph showing the connection of the semiconductor substrate and the lid 14A7 for retaining the reference electrode-holding member 1. The reference electrode-holding member and the semiconductor substrate closely adhere to each other when the lid-mounting screw 15A1 is tightened, as shown in FIG. 15(A). The reference electrode-holding member is separated from the semiconductor substrate by the spring 14A9 when the lid-mounting screw is loosened, as shown in FIG. 15(B), and the printed circuit board can be removed.

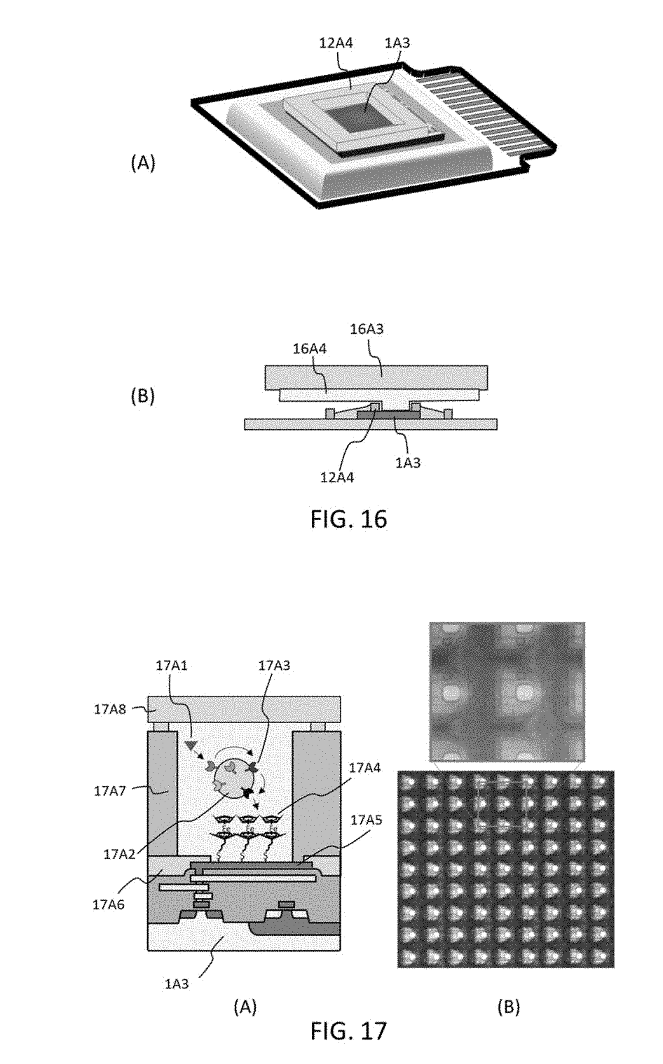

FIG. 16 shows a configuration drawing for the case in which a flow channel using PDMS (polydimethylsiloxane, hereinafter simply referred to as “PDMS”) is formed on the semiconductor substrate 1A3. In FIG. 16, the reference symbol 12A4 is a silicone sheet frame, 1A3 is a semiconductor substrate, 16A3 is a PDMS-holding platform, and 16A4 is PDMS.

The surface of the semiconductor substrate 1A3 is often washed, undergoes interface treatment, has molecules deposited thereon in advance, or undergoes other treatment, and the entire surface of the semiconductor substrate 1A3 is preferably open without the PDMS being secured, as shown in FIG. 16(A). On the other hand, as described below, numerous electrodes are formed on the semiconductor substrate 1A3, and therefore, a sample liquid must be allowed to readily flow to each electrode. Accordingly, the surface of the semiconductor substrate 1A3 can be stratified to form a flow channel. FIG. 16(B) is a cross-sectional schematic view of when a flow channel is formed. A method is used in which the PDMS 16A4 provided with a flow channel is secured to the PDMS-holding platform 16A3 serving as a PDMS support platform, and is made to closely adhere to the surface of the semiconductor substrate 1A3, as shown in the cross-sectional schematic view of FIG. 16(B). At this point, the silicone sheet frame 12A4 and the PDMS 16A4 are preferably not allowed to be in contact with each other to improve the close adhesion of the semiconductor substrate 1A3 with the PDMS 16A4. When the PDMS 16A4 provided with a flow channel is to be disposed on the surface of the semiconductor substrate 1A3, holes are opened in the PDMS 16A4 in the 12A9 positions shown in FIG. 12(D). As such, the holes in the PDMS 16A4 will correspond to the opening 7A42 of the first flow channel 7A4 and the opening 7A62 of the second flow channel 7A6 in the reference electrode-holding member 1, and the sample liquid can be introduced to and discharged from the flow channels formed by the semiconductor substrate 1A3 and the PDMS 16A4. When a plurality of the first flow channel and the second flow channel is to be formed, a plurality of holes can be formed in corresponding locations in the PDMS 16A4 as well.

FIG. 17 shows an example of detecting a biological substance using the substance detection device of the present disclosure, FIG. 17(A) being a cross-sectional schematic view, and FIG. 17(B) being a photomicrograph of the electrode portion. In FIG. 17, the reference symbol 17A1 is a molecule to be detected, 17A2 is a bead, 17A3 is a probe molecule, 17A4 is a self-assembled monolayer, 17A5 is an electrode, 17A6 is polyimide, 17A7 is SU-8 (a type of negative photoresist, hereinafter merely referred to as “SU-8”), 17A8 is PDMS, and 1A3 is a semiconductor substrate.

An integrated circuit is formed on the semiconductor substrate 1A3, and an electrode 17A5 fabricated using gold, silver, platinum, or other metal, or diamond, silicon, or other semiconductor is formed on the wiring layer of the topmost layer, whereby an electrochemical sensor is formed. Among the metals mentioned above, gold is preferably used as the electrode in that gold is a metal with low ionization tendency and is stable even in contact with a solution. The surface of the semiconductor substrate 1A3 is provided with polyimide 17A6 as a protective film and a SU-8 micro flow channel 17A7, and a PDMS 17A8 in which relatively large flow channels are formed is applied in close adhesion thereon. In order to prevent contamination of the electrode 17A5, a self-assembled monolayer 17A4 is disposed on the electrode 17A5. A trench is formed by the SU-8 17A7 on the sensor, and enzyme, an antibody, a primer, or other detection molecule 17A3 is immobilized on a bead having a diameter of about 10 microns and placed in the trench. The molecule 17A1 to be detected produces a chemical reaction with the probe molecule 17A3 on the bead 17A2, and the result of the reaction is detected as variation in electric potential.

When the bead 17A2 is a magnetic bead, the bead can be brought near the surface of the semiconductor substrate 1A3 by the magnet and the detection signal is increased. In the substance detection device shown in FIG. 14, the magnet 14A3 can be inserted directly below the semiconductor substrate 1A3. When the bead 17A2 covers the electrode 17A5, there is a drawback in that the chemical reaction substance is no longer supplied to the electrode 17A5. In order to avoid this drawback, the center of the trench and the center of the electrode 17A5 are offset from each other, as shown in FIG. 17(B).

The results of detecting glucose in blood using the above-described electrochemical sensor configuration have been reported in the following documents. (H.Komori, K.Niitsu, J.Tanaka, Y.Ishige, M.Kamahori, and K.Nakazato, “An Extended-Gate CMOS Sensor Array with Enzyme immobilized Microbeads for Redox-Potential Glucose Detection”,BIOCAS,2014, and H.Anan, M.Kamahori, Y.Ishige, and K.Nakazato, “Redox-potential sensor array based on extended-gate field-effect transistors with-ferrocenylalkanethiol-modified gold electrodes”, Sensors and Actuators B: Chemical, 187, 254-261, 2013)

In view of the above, three enzymes, namely, hexokinase, glucose-6-phosphate dehydrogenase, and diaphorase, are immobilized on a single bead 17A2 using avidin-biotin binding, and 11-FUT is used as the self-assembled monolayer 17A4.

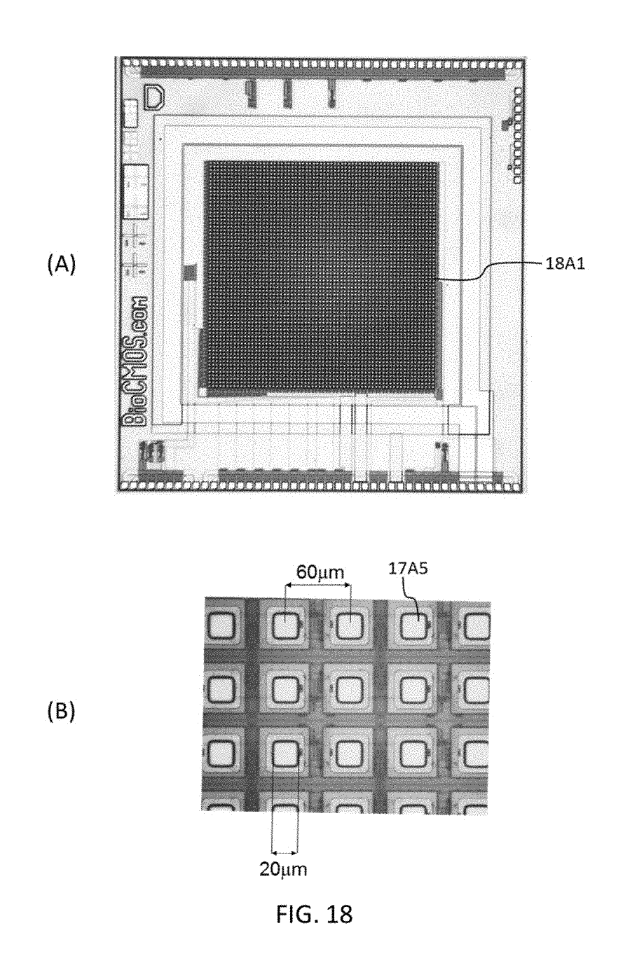

FIG. 18(A) is a photograph of the sensor array provided to the first semiconductor substrate 1A3, and FIG. 18(B) is an enlarged photograph of the sensor array prior to formation of the SU-8 17A7. In this circuit, 64×64 sensors are arranged in an array, and 4096 types of reaction-induced variations in electric potential can be simultaneously detected in parallel. In FIGS. 18(A) and 18(B), the reference symbol 18A1 is a sensor array, and 17A5 is an electrode.

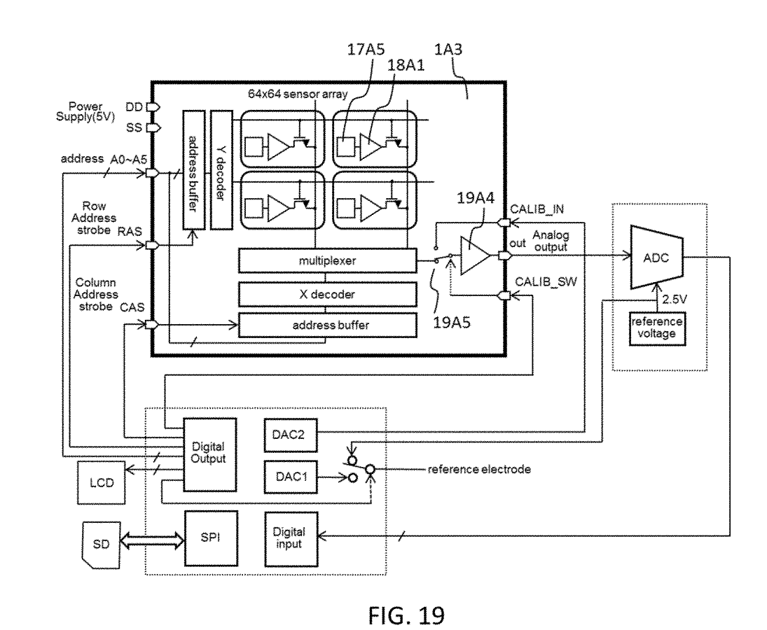

FIG. 19 shows the configuration of the interface circuit and the first semiconductor substrate of the substance detection device of the present disclosure. In FIG. 19, the reference symbol 1A3 is a semiconductor substrate, 17A5 is an electrode, 18A1 is a sensor array, 19A4 is an output buffer, and 19A5 is a switch sensor circuit for correction. The electric potential detection sensor of patent document 1 is used as the 19A3. Signals are outputted by way of the buffer circuit 19A4, but since error that occurs in the buffer circuit and thereafter is corrected, voltage is applied from the exterior by the switch 19A5 to measure the results, and the error is reduced to 1/10 or less.

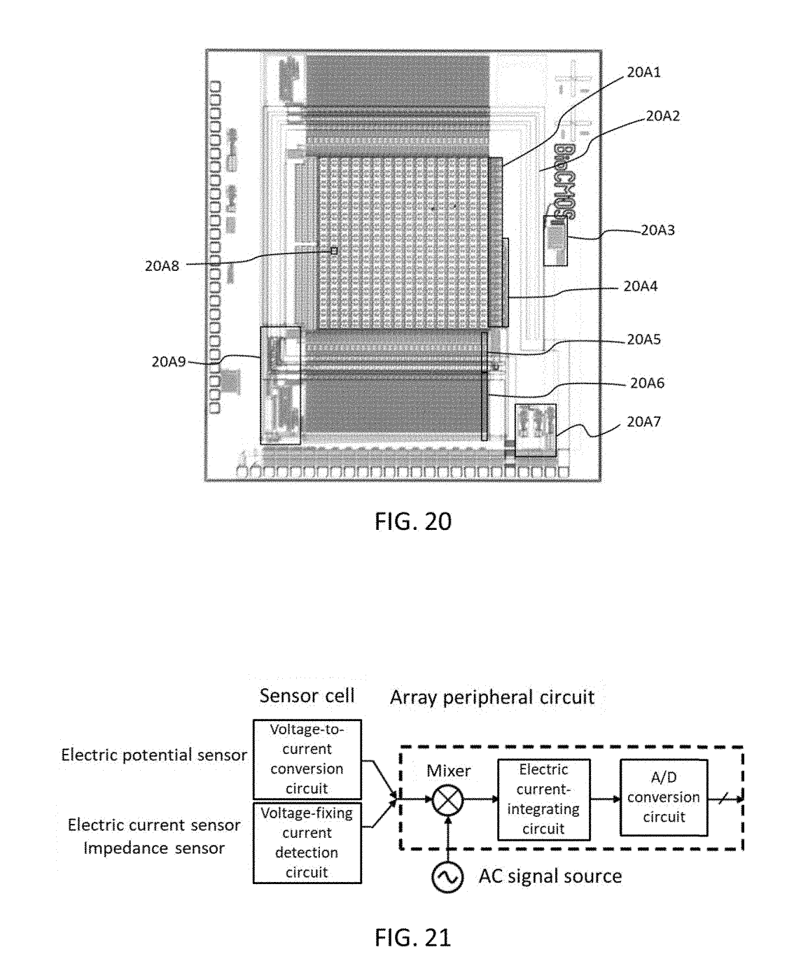

FIG. 20 is a photograph of the second semiconductor substrate used in the substance detection device of the present disclosure, the sensor array for simultaneously detecting changes in electric potential, electric current, and impedance being integrated on the second semiconductor substrate. In FIG. 20, the reference symbol 20A1 is a Y decoder, 20A2 is a heater, 20A3 is a temperature gauge, 20A4 is a Y address buffer, 20A5 is an electric current integrator, 20A6 is an A/D converter and a parallel-in/serial-out shift register, 20A7 is a temperature gauge preamplifier, 20A8 is a sensor cell, and 20A9 is a clock generation circuit.

Sensor cells 20A8 for detecting electric potential, electric current, and impedance are arranged on the substrate in the form of a 32×32 array of 1024 units. Integrated on the substrate are the Y decoder 20A1, the Y address buffer 20A4, the electric current integrator 20A5, the A/D converter and parallel-in/serial-out shift register 20A6, and the clock generation circuit 20A9. Furthermore integrated on the substrate are wiring (heater) 20A2 for controlling temperature, a temperature gauge 20A3, and a preamplifier 20A7 of the temperature gauge.

The chemical reaction time is ordinarily a length of about several milliseconds, and this is a six-digit-long processing time for an integrated circuit. There is no advantage to performing detection time at high speed, and effectively using a long period of time is effective for improving precision. A method for increasing precision is to use cumulative signals and average the signals, rather than using an isolated signal. Electric current is a time derivative of electric charge and is therefore accumulated as a charge in a capacitor, whereby the electric current can be time integrated. In order to integrate the electric potential, the electric potential is temporarily converted to electric current which is accumulated as charge in a capacitor.

FIG. 21 shows the method for detecting the electric potential, electric current, and impedance. In the drawing, a sensor cell and an array peripheral circuit are provided. The sensor cell is provided with a voltage-to-current conversion circuit and a voltage-fixing current detection circuit. The array peripheral circuit is provided with a mixer, an electric current-integrating circuit, and an A/D conversion circuit.

Impedance is alternating current and is rectified by the mixer. Integration using a downstream capacitor serves as a low-pass filter. The electric potential is converted to electric current in the sensor array and is integrated in the array peripheral circuit. Using this configuration makes it possible to process electric potential, electric current, impedance signals using a single array peripheral circuit.

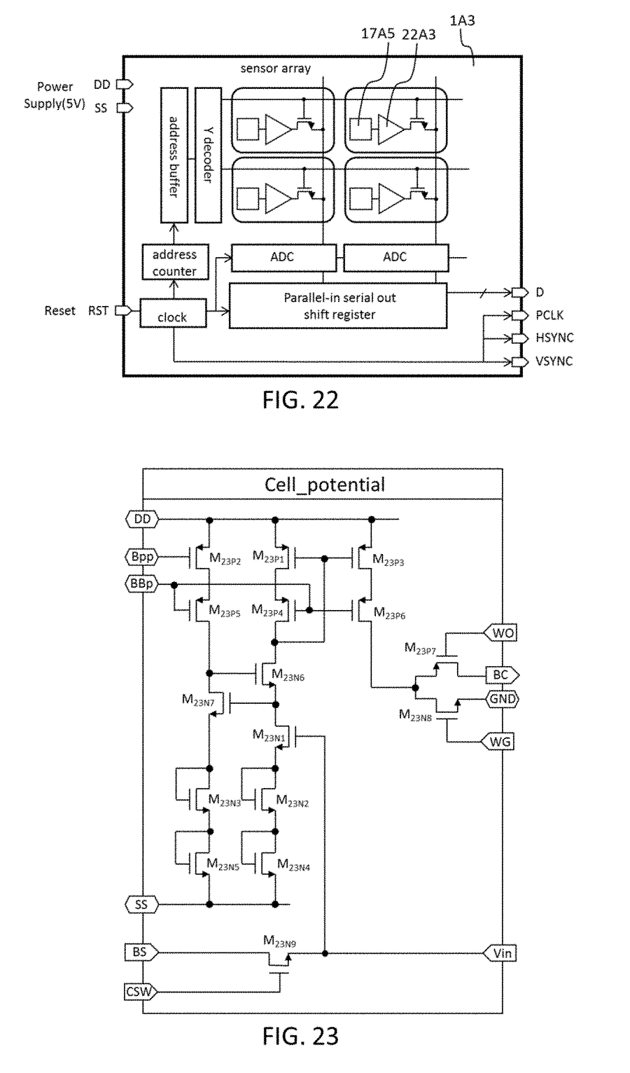

FIG. 22 shows the configuration of the semiconductor IC. The sensor circuit 22A3 uses either the next-described voltage-to-current conversion circuit or voltage-fixing current conversion circuit. The detection signal is outputted as a digital signal by A/D conversion. A dual slope type, an electric current mode A-E scheme, or the like is used as the A/D conversion circuit.

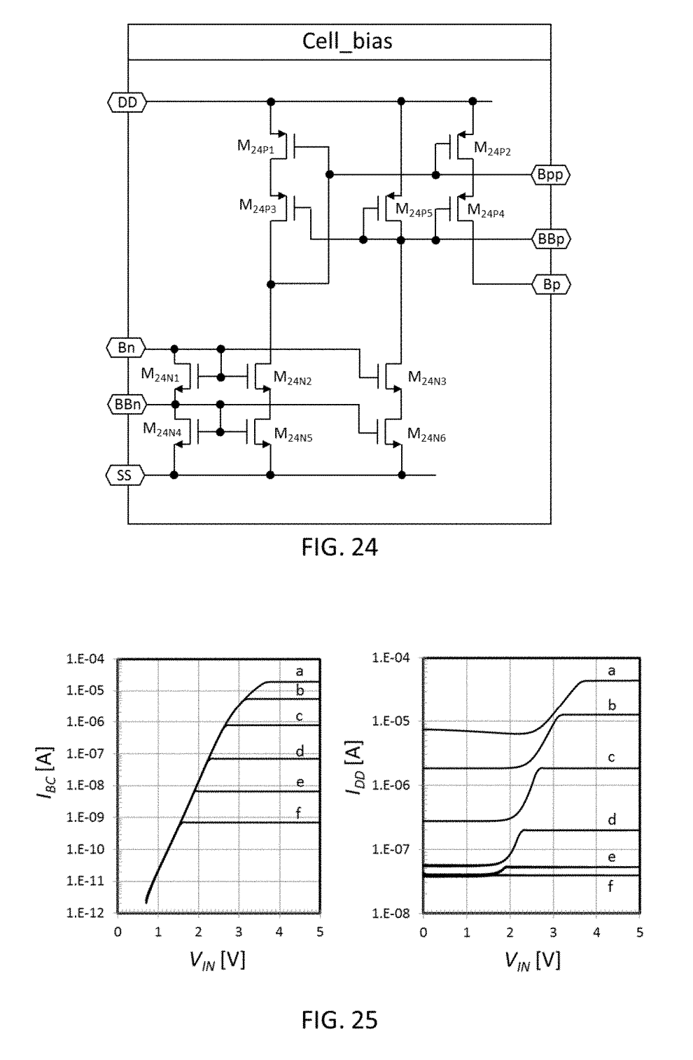

FIG. 23 is a circuit diagram of the voltage-to-current conversion-type sensor cell, and constant voltages Bpp, BBp are supplied by the cell bias circuit of FIG. 24. Two-stage, source-degenerated field-effect transistors M23N2, M23N3, M23N4, M23N5 are provided in order to triple the range of the detection voltage. The field-effect transistor M23N7 is for fixing the drain voltage of the transistor M23N1 of the sensor, and the field-effect transistor M23N6 is for causing the transistor M23N7 to operate in a saturation region. The advantage of this circuit is that the electric current flowing through the field-effect transistors M23P1, M23P4, M23N6, M23N1, M23N2, M23N4 is not allowed to exceed the electric current flowing through the field-effect transistors M23P2, M23P5, M23N7, M23N3, M23N5, even when the input voltage VIN increases. The upper limit of power consumed by the circuits can thereby be set by the constant voltage Bn.

FIG. 25 shows the result of measuring the electric current and voltage characteristics circuits in FIG. 23. In the charts, IBC is to the electric current of the output BC, and IDD is the electric current that flows to the circuits overall. The letters a, b, c, d, e, and f correspond to the voltages 2 V, 1.8 V, 1.6V, 1.4V, 1.2V, and 1V, respectively, of Bn. Setting the voltage of Bn to 1.6 V allows a 2 V-wide detection range to be obtained, and allows a 2-μA upper limit to be set to the electric current of the circuit, even when the VIN has increased.

The voltage-to-current conversion circuit is affected by threshold value variations in the transistor. In order to correct threshold value variations, a transistor M23N9 is provided to the circuit of FIG. 23.

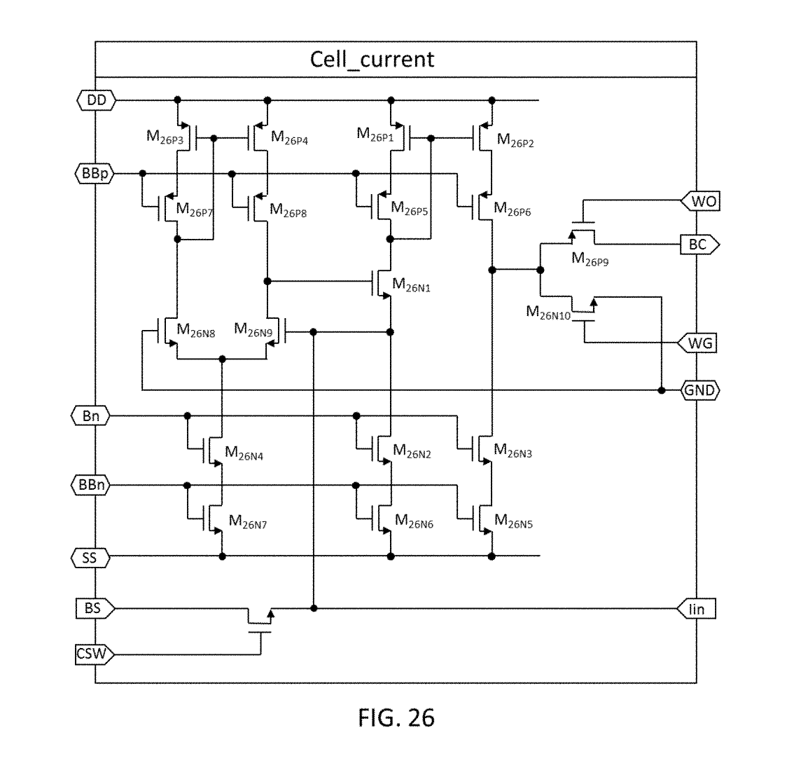

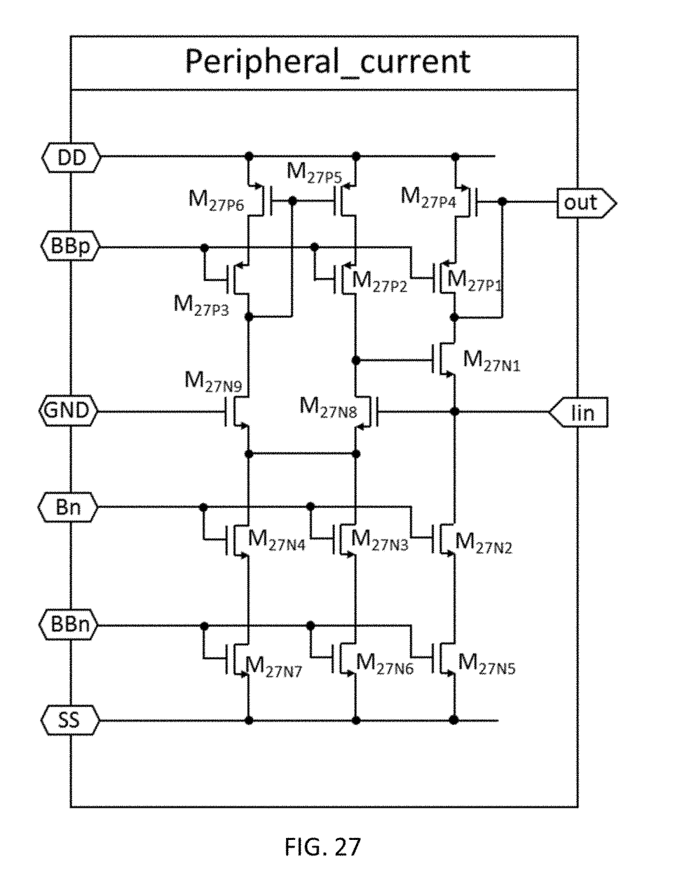

FIG. 26 is a circuit diagram of the electric current sensor cell for detecting the electric current with the electric potential fixed. FIG. 27 shows the electric current receiving unit of the array peripheral part for receiving an electric current signal from the sensor cells. Obtained is the ‘out’ electric potential for moving the electric current, with the electric potential of the electric current input unit Iin in a fixed state.

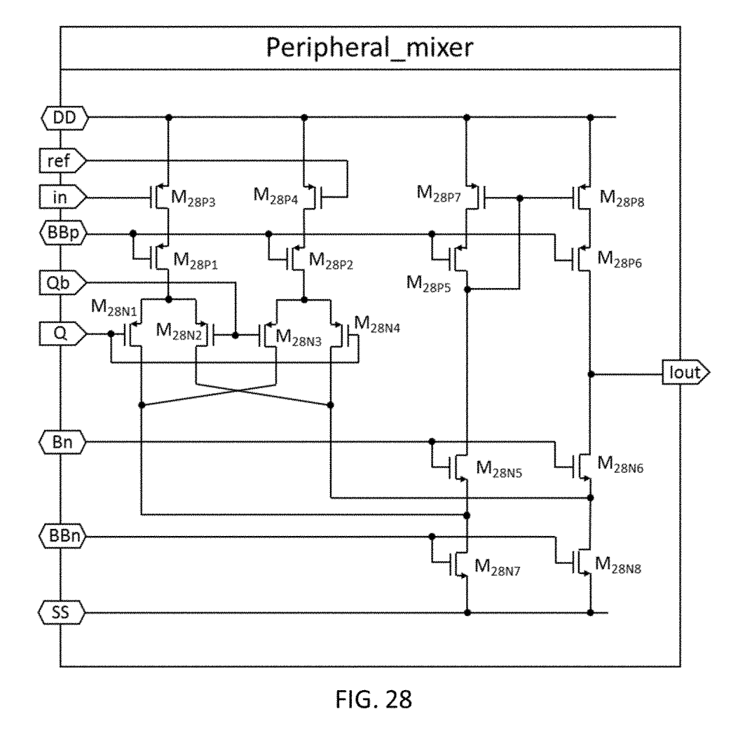

FIG. 28 is an electric current mixer circuit. The difference between the electric current flowing through M23P1 and M23P3 and the electric current flowing through M23P2 and M23P4, and the product of the electric current of the signal Q are outputted to lout. The signal Q is a logic signal, and the amplitude is therefore large and the effect on the clock feed-through is considerable. In order to alleviate this drawback, an operational transconductance amplifier configuration is used for the cascode transistors M28P1, M28P2 and repeating cascode connections M28P5, M28P6, M28P7, M28P8, M28N5, M28N6, M28N7, M28N9.

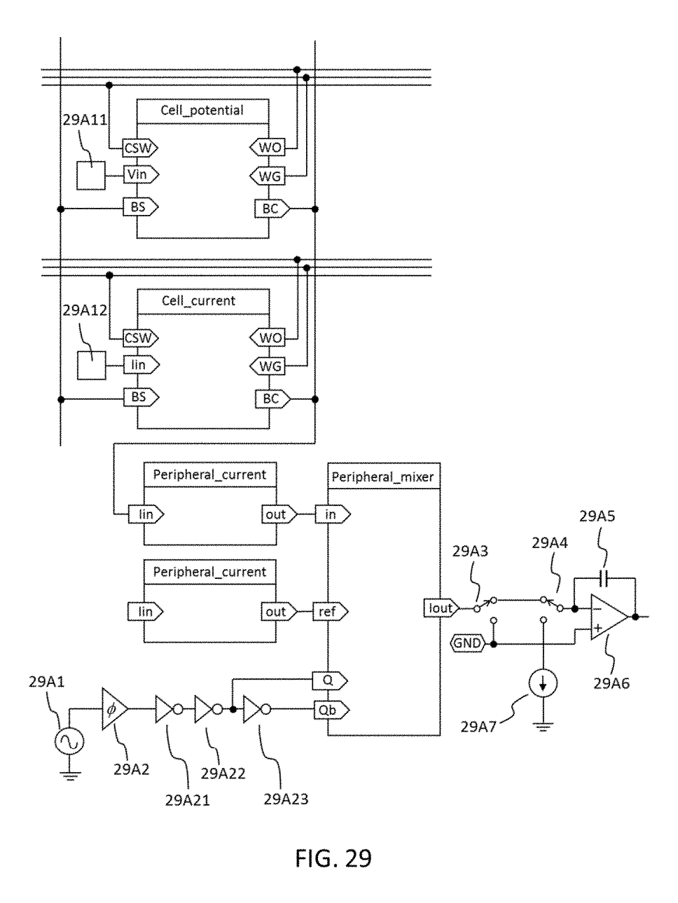

FIG. 29 is a diagram with the circuits connected together. In FIG. 29, the reference symbol 29A is an AC signal source (AC power supply), 29A2 is a phase shifter, 29A21, 29A22, 29A23 are inverter circuits, 29A3 is a sample-hold switch (switch, switching means), 29A4 is a capacitor discharge switch (switch, switching means), 29A7 is a power supply for capacitor discharge, 29A5 is a capacitor, and 26A6 is an operational amplifier.

The output voltage from the sensor cell passes through the mixer and is thereafter stored as charge in the capacitor 29A5. In order to reset the charge level, the charge of the capacitor is drawn out until the voltage of the operational amplifier 29A6 has reach GND level by constant current source 29A7. The switch 29A3 is for holding the output voltage of the operational amplifier.

The operating voltage of the operational amplifier is limited and the upper and lower limits of the output voltage of the operational amplifier are set, and when the upper limit or the lower limit is reached, the charge of the capacitor is discharged and the number of cycles is counted, whereby the dynamic range of the sensor can be increased.

The semiconductor IC of FIG. 20 is provided with a mixer, an electric current-integrating circuit, and an A/D converter and parallel-in/serial-out shift register, above and below the sensor array. One can integrate signals while the other is outputting detection signals, and integrating time can thereby be doubled.

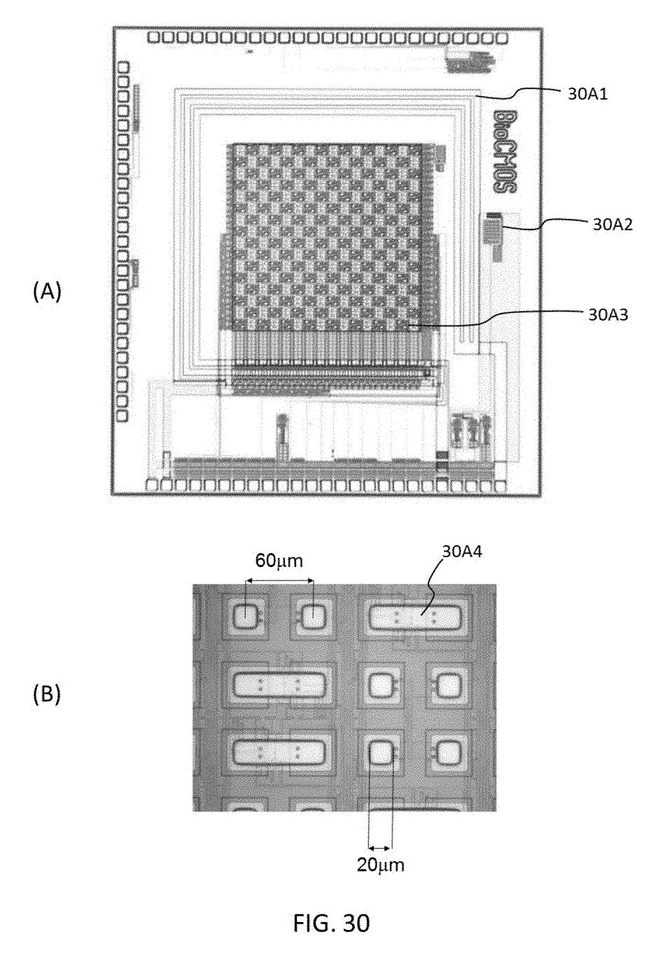

The foregoing is a semiconductor IC for detecting biological substance by variations in electric potential, electric current, and impedance, and it is also possible to control biological substance on the semiconductor substrate. FIG. 30 is a photograph of a semiconductor IC in which an arbitrary electric potential is stored in an arbitrary location and then applied to an electrode. Electrochemical measurements can be carried out while the biological substance is controlled by electrophoresis and temperature control.

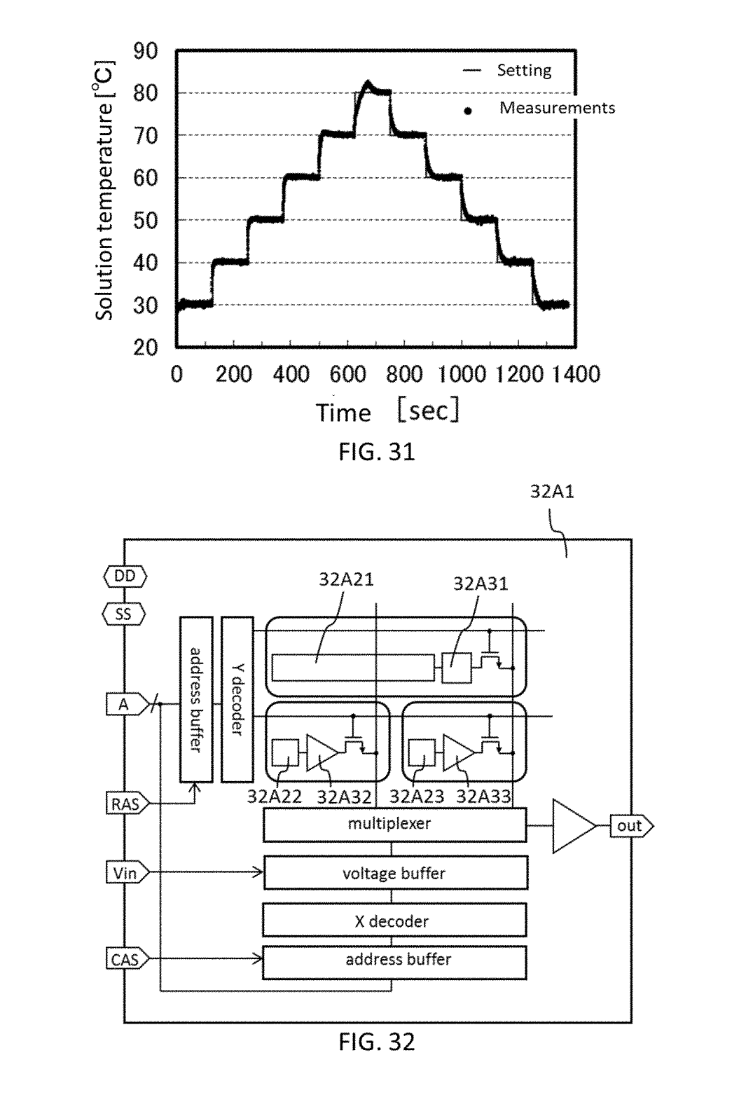

The temperature is capable of molecule amplification as seen in PCR. It is also effective to control temperature in order to enhance the precision of detection signals. When a sample liquid and a buffer liquid are supplied in alternating fashion to the semiconductor substrate, temperature-induced signal variations will occur when there is a temperature difference between the two solutions. In order to eliminate such variations, it is effective to make the temperature of the solutions on the chip constant prior to arrival at the sensors. FIG. 31 shows that temperature can be controlled with accuracy as a result of the temperature on the substrate being controlled using a temperature gauge and a heater on the semiconductor substrate. In FIG. 30, the reference symbol 30A1 is a heater, 30A2 is a temperature gauge, 30A3 is an array of voltage application cells and sensor cells, and 30A4 is a voltage application electrode.

FIG. 32 shows the configuration of the semiconductor substrate of FIG. 30. The electric potential held in analog memory 32A31 is applied to an electrode 32A21. The analog memory is composed of a sample-hold circuit and is capable of holding an electric potential for about 10 seconds using an 1pF capacitor. In order to hold an electric potential for a long period of time, it is effective to perform a refresh operation and use a master-slave configuration so that the electric potential does not vary during sampling.

Electric potential is converted to an X address, sequentially stored as a single row in a voltage buffer, and thereafter transferred to the row specified by the Y address. Any voltage can thereby be applied to all electrodes in the array.

Electrophoresis is the standard method used for analyzing biomolecules and is performed by applying voltage near 1000 V at a distance of 10 cm. When this method is performed on a semiconductor substrate, the electrode distance is reduced to 100 microns, and 1 V is sufficient to obtain the same electric field.

Photoelectric current must be suppressed to hold electric potential and a shielded environment is required. Therefore, an optical detection method cannot be used. For this reason, it is only possible to use an electrical detection method to detect a biological substance, and electrodes 32A22, 32A23 for detecting electric potential and sensor cells 32A32, 32A33 for detecting electric potential are provided on the semiconductor IC. The sensor circuit may also bring together the electric potential, electric current, and impedance used in FIG. 20.

In accordance with the invention of the example described above, there is provided a substance detection device for electrochemically detecting a substance in a solution with the aid of a sensor 5A6 in contact with the solution using a reference electrode 5A4 for establishing an electrical reference of the solution, the substance detection device comprising: a sample flow channel 5A1 for supplying a sample liquid containing a substance to be detected to a sensor 5A6 in contact with the solution; a reference electrode flow channel 5A2 for supplying a buffer liquid for blocking the sample liquid from reaching the reference electrode 5A4 and supplying the buffer liquid to the sensor 5A6; and a drainage flow channel 5A3 for discharging the buffer liquid and the sample liquid that has passed by the sensor 5A6. Therefore, a sample in a solution that flows through the sample flow channel does not reach the reference electrode 5A4.

In this example, a configuration is used in which the reference electrode flow channel 5A2 merges at a midway point in the flow channel that flows to the sensor 5A6 in one of the sample flow channels 5A1 among the plurality of sample flow channels 5A1. Therefore, it is easy to adopt a configuration in which the reference electrode 5A4 is set at a distance from the sensor 5A6, resulting in a configuration in which the reference electrode is unlikely to become contaminated.

### INDUSTRIAL APPLICABILITY

The substance detection device using a semiconductor IC sensor of the present disclosure provides a method for electrochemical measurement method having good operability and high sensitivity, is capable of readily detecting DNA, biomolecules, and other substances in large quantities, and creates life innovations with innovative testing and diagnostic methods in the fields of medical care, health, environment, and other life sciences. This substance detection device makes high-precision testing possible with the aid of a sensor chip that uses a high-quality semiconductor IC, and, by providing a large quantity of sensor chips to medical science, pharmacology, chemistry and other bio-related industries, is capable of readily performing testing with good operability and high sensitivity, and can make a large contribution to the welfare of humanity.

[Key]

1: Reference electrode-holding member, 1-1: Substance detection device, 1A1: Conventional reference electrode, 1A2: Solution, 1A3: Electronic circuit (semiconductor IC), 1A4: Voltage source, V1: Reference electric potential of the solution, V2: Reference electric potential of the electronic circuit (ordinarily, ground electric potential), 2A1: Electroconductive wire, 2A2: Glass tube, 2A3: Saturated solution, 2A4: Cork, 2A6: Diffusion of saturated liquid into the solution, 3A1: Syringe, 3A2: Sample liquid, 3A3: Buffer liquid, 3A4: Flow channel switch valve, 3A8: Electric wire, 3A10: Flow channel joint, 4A1: Foam, 5A1: Sample liquid, 5A2: Reference electrode flow channel, 5A3: Drainage flow channel, 5A4: Reference electrode, 5A6: Electrochemical sensor, 7A1: Base material, 7A2: reference electrode-holding hole, 7A3: Reference electrode flow channel, 7A4: first flow channel, 7A5: Sensor-facing surface, 7A6: Second flow channel, 7A7: Mounting hole, 7A8: Sheet part, 7A21: Distal end of the reference electrode-holding hole, 7A31: Opening, 7A32: Other end of the reference electrode flow channel, 7A41: Opening, 7A42: Opening, 7A51: Third flow channel, 7A61: Opening, 7A62: Opening, 8A1: Reference electrode-securing screw, 8A3: O-ring, 9A3: Drainage, 9A4: Six-way valve (valve), 9A5, 9A7, 9A8: Three-way valve (valve), 9A6: Reference electrode wash liquid, 9A9: Buffer liquid, 9A10: Drainage, 9A13: Tube for metering sample liquid, 12A1: Printed circuit board, 12A3: Bonding wire, 12A4, 12A5: Silicone sheet frames, 12A6: Silicone paste, 12A7: Counter electrode for detecting water leakage, 12A8: Hole from removing printed circuit board, 12A9: Solution entry/exit position for the solution holder, 13A1: Tweezers for removing the printed circuit board, 14A1: Printed circuit board-holding part, 14A2: Pin insertion hole, 14A3: Magnet, 14A4: Silicone sheet frame, 14A7: Lid for retaining the reference electrode-holding member 1, 14A8: Alignment pin of the reference electrode-holding member 1, 14A9: Spring, 14A10: Silicone sheet (sheet material) for close adhesion, 14A11: Fixed stainless steel plate, 15A1: Lid-mounting screw, 16A3: PDMS-holding platform, 16A4: PDMS, 17A1: Molecule to be detected, 17A2: Bead, 17A3: Probe molecule, 17A4: Self-assembled monolayer, 17A5: Electrode, 17A6: Polyimide, 17A7: SU-8, 17A8: PDMS, 18A1: Sensor cell array, 19A4: Output buffer, 19A5: Correction switch, 20A1: Y decoder, 20A2: Heater, 20A3: Temperature gauge, 20A4: Y address buffer, 20A5: Electric current integrator, 20A6: A/D converter and parallel-in/serial-out shift register, 20A7: Temperature gauge preamplifier, 20A8: sensor cell, 20A9: Clock generation circuit, 22A3: Sensor circuit, M_{aNb} (where a, b are numbers): NMOS field effect transistor, M_{aPb} (where a, b are numbers): PMOS field effect transistor, 29A1: AC signal source, 29A2: Phase shifter, 29A21, 29A22, 29A23: Inverter circuits, 29A3: Sample-hold switch, 29A4: Capacitor discharge switch, 29A7: Electric current source for capacitor discharge, 29A5: Capacitor, 29A6: Operational amplifier, 30A1: Heater, 30A2: Temperature gauge, 30A3: Array of sensor cells and voltage application cells, 30A4: Voltage application electrode, 32A31: Analog memory, 32A22, 32A23: Electrodes for detection electric potential, 32A32, 32A33: Sensor cells for detecting electric potential

1-9. (canceled)

10. A reference electrode-holding member to be used in a substance detection device for electrochemically detecting a substance in a solution using a reference electrode for establishing an electrical reference of the solution, wherein
the reference electrode-holding member comprises at least a base material, a reference electrode-holding hole formed in the base material, a reference electrode flow channel, and a first flow channel,
a sensor-facing surface that faces an electrochemical sensor of the substance detection device is formed in the base material,
the reference electrode-holding hole is formed in a portion other than the sensor-facing surface of the base material and is capable of receiving insertion of and holding the reference electrode,
one end of the reference electrode flow channel forms an opening in a portion other than the sensor-facing surface of the base material, and the other end is positioned inside the base material,
the distal end of the reference electrode-holding hole is in communication with the reference electrode flow channel in a location other than the end part of the reference electrode flow channel,
one end of the first flow channel forms an opening in a portion other than the sensor-facing surface of the base material and the other end forms an opening in the sensor-facing surface of the base material, and
the other end of the reference electrode flow channel and the first flow channel are in communication inside the base material.

11. The reference electrode-holding member of claim 10, further comprising a second flow channel, of which one end forms an opening in a portion other than the sensor-facing surface of the base material, and the other end forms an opening in the sensor-facing surface of the base material.

12. The reference electrode-holding member of claim 10, wherein the first flow channel comprises at least one or more branching flow channels, and the end part of the branching flow channel branched from the first flow channel forms an opening in the sensor-facing surface.

13. The reference electrode-holding member of claim 11, wherein the first flow channel comprises at least one or more branching flow channels, and the end part of the branching flow channel branched from the first flow channel forms an opening in the sensor-facing surface.

14. The reference electrode-holding member of claim 10, wherein two or more of the first flow channel are provided, and one end of each of the first flow channels forms an opening in a portion other than the sensor-facing surface of the base material, the other end forms an opening in the sensor-facing surface of the base material, and at least one of the first flow channels is in communication with the reference electrode flow channel inside the base material.

15. The reference electrode-holding member of claim 11, wherein
two or more of the first flow channel are provided, and
one end of each of the first flow channels forms an opening in a portion other than the sensor-facing surface of the base material, the other end forms an opening in the sensor-facing surface of the base material, and at least one of the first flow channels is in communication with the reference electrode flow channel inside the base material.

16. The reference electrode-holding member of claim 10, wherein a flow channel is formed in the sensor-facing surface.

17. The reference electrode-holding member of claim 11, wherein a flow channel is formed in the sensor-facing surface.

18. The reference electrode-holding member of claim 12, wherein a flow channel is formed in the sensor-facing surface.

19. The reference electrode-holding member of claim 13, wherein a flow channel is formed in the sensor-facing surface.

20. The reference electrode-holding member of claim 14, wherein a flow channel is formed in the sensor-facing surface.

21. The reference electrode-holding member of claim 15, wherein a flow channel is formed in the sensor-facing surface.

22. The reference electrode-holding member of claim 10, further comprising a reference electrode,
the reference electrode being a conductor wire, and at least a portion of the conductor wire being positioned inside the reference electrode flow channel when inserted and held in the reference electrode-holding hole.

23. The reference electrode-holding member of claim 11, further comprising a reference electrode,
the reference electrode being a conductor wire, and at least a portion of the conductor wire being positioned inside the reference electrode flow channel when inserted and held in the reference electrode-holding hole.

24. The reference electrode-holding member of claim 12, further comprising a reference electrode,
the reference electrode being a conductor wire, and at least a portion of the conductor wire being positioned inside the reference electrode flow channel when inserted and held in the reference electrode-holding hole.

25. The reference electrode-holding member of claim 14, further comprising a reference electrode,
the reference electrode being a conductor wire, and at least a portion of the conductor wire being positioned inside the reference electrode flow channel when inserted and held in the reference electrode-holding hole.

26. The reference electrode-holding member of claim 16, further comprising a reference electrode,
the reference electrode being a conductor wire, and at least a portion of the conductor wire being positioned inside the reference electrode flow channel when inserted and held in the reference electrode-holding hole.

27. A substance detection device comprising;
the reference electrode-holding member of claim 22,
an electrochemical sensor for electrochemically detecting a substance in a solution, and, a voltage source.

28. The substance detection device of claim 27, comprising a valve for switching the solution to be supplied to the first flow channel and the reference electrode flow channel.

29. The substance detection device of claim 28, wherein the electrochemical sensor is capable of detecting at least one or more of electric potential, electric current, and impedance.
